(19) United States
(12) Patent Application Publication
(10) Pub. No.: US 2018/0283348 A1
(43) Pub. Date: Oct. 4, 2018

(54) FLUID-DRIVEN MOTOR

(71) Applicant: O2 Waterator Ltd., Netanya (IL)

(72) Inventor: Ehud NAGLER, Kiryat Tivon (IL)

(21) Appl. No.: 15/763,121

(22) PCT Filed: Sep. 26, 2016
(86) PCT No.: PCT/IB2016/055734

§ 371 Date: Mar. 26, 2018

Related U.S. Application Data
(60) Provisional application No. 62/232,490, filed on Sep. 25, 2015.

(51) Int. Cl. F03C 1/38; F03C 1/22; F03C 1/053

(52) U.S. Cl. CPC F03C 1/0444; F03C 1/053; F03C 1/223; F03C 1/226

(57) ABSTRACT

A motor (10) to be driven by a pressurized fluid includes a manifold (16) with an arcuate surface (20) defining a valve opening (22) surrounded by a sealing surface. A cylinder (26) has an aperture (30) cooperating with the arcuate surface (20). The cylinder (26) is pivotally mounted so as to be pivotable between a neutral state in which the aperture faces the sealing surface, an inlet state in which the aperture (30) is in fluid connection with the valve opening (22), and an exhaust in which the aperture (30) is in fluid connection with a drainage volume. A piston (34), deployed in the cylinder (26), is driven to extend by pressure within the cylinder. The piston is linked to a crank (36) so that rotation of a crankshaft (38) causes a cyclic motion of the piston (34) and cylinder (26) from the inlet state for an extension power stroke of the piston (34), through the neutral state and to the exhaust state for a return motion of the piston (34). The pivot axis of the cylinder, preferably implemented using a pivot axle (32), is located between the crankshaft axis and the arcuate surface (20).

### FIELD AND BACKGROUND OF THE INVENTION

The present invention relates to fluid-driven motors and, in particular, a motor suited for operation driven by a pressurized supply of water.

The present invention may be regarded conceptually as an improvement to a motor design that is described in U.S. Pat. Nos. 7,258,057 and 8,881,641. In those cases, a water-driven motor includes a number of cylinders with cylinder heads pivotally mounted around a pipe which serves also as water pressure supply manifold while an output piston rod is anchored to a cam shaft. As the piston rod follows the cam shaft, the angle of the cylinder about the supply manifold varies, thereby bringing a cylinder aperture alternately into overlapping fluid communication with a pressurized water supply and an outlet drain connection of the manifold.

The above arrangement has been found suitable for a wide range of applications, providing a low-cost and reliable water-driven motor capable of generating relatively high torque.

### SUMMARY OF THE INVENTION

The present invention is a fluid driven motor.

According to the teachings of an embodiment of the present invention there is provided, a motor to be driven by a pressurized fluid comprising: (a) a manifold comprising a fluid flow channel for conveying the pressurized fluid, the manifold providing an arcuate surface defining: (i) a valve opening in fluid connection with the fluid flow channel, and (ii) a sealing surface; (b) a cylinder having a cylinder head providing a facing surface configured to cooperate with the arcuate surface, the facing surface having at least one aperture, the cylinder being pivotally mounted about a pivot axis so as to be pivotable between: (i) a neutral state in which the aperture is in facing relation to the sealing surface, (ii) an inlet state, angularly displaced over a range of positions to a first side of the neutral state, in which the aperture is in fluid connection with the valve opening for intake of the pressurized fluid into the cylinder, and (iii) an exhaust, state angularly displaced over a range of positions to a second side of the neutral state, in which the aperture is in fluid connection with a drainage volume for exhaust of the fluid from the cylinder; (c) a piston deployed within the cylinder so as to be driven to extend by pressure of the pressurized fluid introduced to an internal volume of the cylinder; and (d) a crank associated with a crankshaft, the piston being linked to the crank such that rotation of the crankshaft about a crankshaft axis delimits a cyclic motion of the piston and the cylinder in which the cylinder assumes the inlet state for an extension power stroke of the piston, passes through the neutral state and assumes the exhaust state for a return motion of the piston, wherein the pivot axis of the cylinder is located between the crankshaft axis and the arcuate surface.

According to a further feature of an embodiment of the present invention, the pivot axis of the cylinder is located in a middle third of a distance between the crankshaft axis and the arcuate surface.

According to a further feature of an embodiment of the present invention, the pivot axis of the cylinder is located closer to the arcuate surface than to the crankshaft axis.

According to a further feature of an embodiment of the present invention, the piston is formed with a piston head, carrying a seal for sealed engagement with a portion of the cylinder, and a piston body, rigidly interconnected with the piston head, the piston body extending from the piston head to the crank.

According to a further feature of an embodiment of the present invention, the cylinder is pivotally mounted on a pivot axle which traverses the cylinder, and wherein the piston body is formed with a slot for accommodating the pivot axle while allowing a range of axial motion of the piston.

According to a further feature of an embodiment of the present invention, the piston head seal engages a portion of the cylinder having a first internal diameter, and wherein the piston body has one or more sliding bearing surfaces for maintaining alignment of the piston within the cylinder, the sliding bearing surfaces being circumscribed by a virtual cylinder of second diameter smaller than the first diameter.

According to a further feature of an embodiment of the present invention, there is also provided a piston guide insert at least partially circumscribing the piston body, the piston guide insert providing sliding abutment surfaces for contacting the sliding bearing surfaces of the piston body, the piston guide insert being received within the cylinder.

According to a further feature of an embodiment of the present invention, the sliding abutment surfaces are a plurality of isolated surfaces that are discontinuous around the piston body.

According to a further feature of an embodiment of the present invention, the arcuate surface and the facing surface are deployed with a clearance, the motor further comprising a resiliently-mounted seal arrangement forming a seal between the aperture and the valve opening in the inlet state, and for sealing the aperture against the sealing surface in the neutral state.

According to a further feature of an embodiment of the present invention, the resiliently-mounted seal is biased by pressure within the fluid flow channel of the manifold to enhance sealing of the resiliently-mounted seal.

According to a further feature of an embodiment of the present invention, the cylinder and the piston are formed primarily from molded plastic.

According to a further feature of an embodiment of the present invention, the drain volume is an internal volume of a housing that houses the cylinder and the piston, the housing having at least one exhaust hole for allowing egress of the fluid from the internal volume.

According to a further feature of an embodiment of the present invention, in the exhaust state, the aperture is in fluid connection with a second valve opening formed in the arcuate surface, the second valve opening being in fluid communication with a second fluid flow channel of the manifold, for conveying exhaust fluid from the cylinder.

According to a further feature of an embodiment of the present invention, there is also provided a control valve arrangement selectively assuming: (a) a first state in which the control valve arrangement connects the fluid flow channel to a source of pressurized fluid and the second fluid flow channel to a drainage line, thereby driving the motor in a first direction; and (b) a second state in which the control valve arrangement connects the second fluid flow channel to a source of pressurized fluid and the fluid flow channel to a drainage line, thereby driving the motor in a direction opposite to the first direction.

According to a further feature of an embodiment of the present invention, the cylinder is one of at least three similar cylinders, and the piston is one of at least three similar pistons, all of the pistons being connected in driving relation to the crankshaft.

According to a further feature of an embodiment of the present invention, the cylinders are arranged in a radial motor configuration.

According to a further feature of an embodiment of the present invention, the cylinders are arranged in an inline motor configuration.

According to a further feature of an embodiment of the present invention, there is also provided a drive system comprising: (a) the aforementioned motor; and (b) a source of pressurized fluid connected so as to provide pressurized fluid to the fluid flow channel of the manifold, the source of pressurized fluid providing fluid at a pressure of between 2 and 10 bar.

According to a further feature of an embodiment of the present invention, the pressurized fluid is water.

### BRIEF DESCRIPTION OF THE DRAWINGS

The invention is herein described, by way of example only, with reference to the accompanying drawings, wherein:

FIG. 1 is a schematic overview of a system including a fluid pressure-driven motor, constructed and operative according to an embodiment of the present invention;

FIG. 2 is an enlarged partial isometric view of the inside of the motor of FIG. 1;

FIG. 3A is a schematic representation of the geometry of valve operation in a motor constructed according to the teachings of U.S. Pat. Nos. 7,258,057 and 8,881,641;

FIG. 3B is a schematic representation of the geometry of valve operation in the motor of FIG. 1;

FIG. 4 is an enlarged partially cut-away isometric view of the inside of the motor of FIG. 1;

FIGS. 5A and 5B are isometric views of an individual cylinder assembly shown together with a crankshaft and part of a manifold, the cylinder assembly being shown in an inlet state and an exhaust state, respectively;

FIGS. 6A-6C are plan views of the individual cylinder assembly of FIG. 5A shown in a neutral state, an inlet, state and. an exhaust state, respectively;

FIG. 7A is a cut-away isometric view similar to FIG. 5A;

FIG. 7B is an enlarged partial cut-away isometric view similar to FIG. 5B;

FIG. 8 is an enlarged isometric view of a region of the motor of FIG. 1 showing the cooperation of the cylinder head with the manifold valve;

FIG. 9 is an exploded isometric view of a cylinder assembly from. the motor of FIG. 1; and

FIGS. 10A-10B are cut-away isometric views illustrating the cylinder and a piston guide insert before and after insertion, respectively.

### DESCRIPTION OF THE PREFERRED EMBODIMENTS

The present invention is a fluid driven motor.

The principles and operation of motors according to the present invention may be better understood with reference to the drawings and the accompanying description.

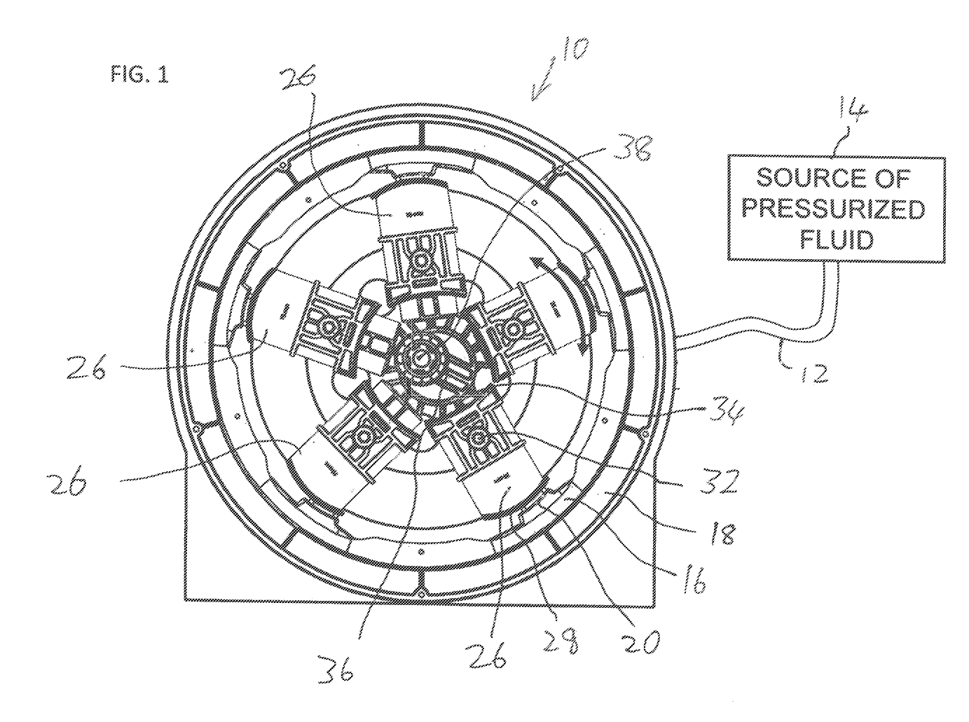

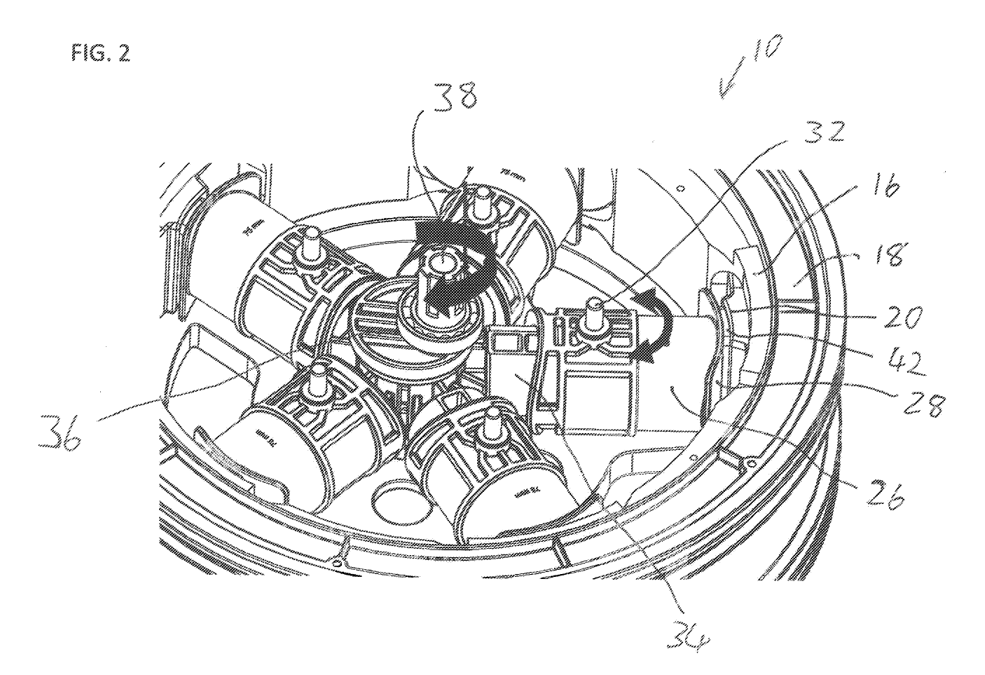

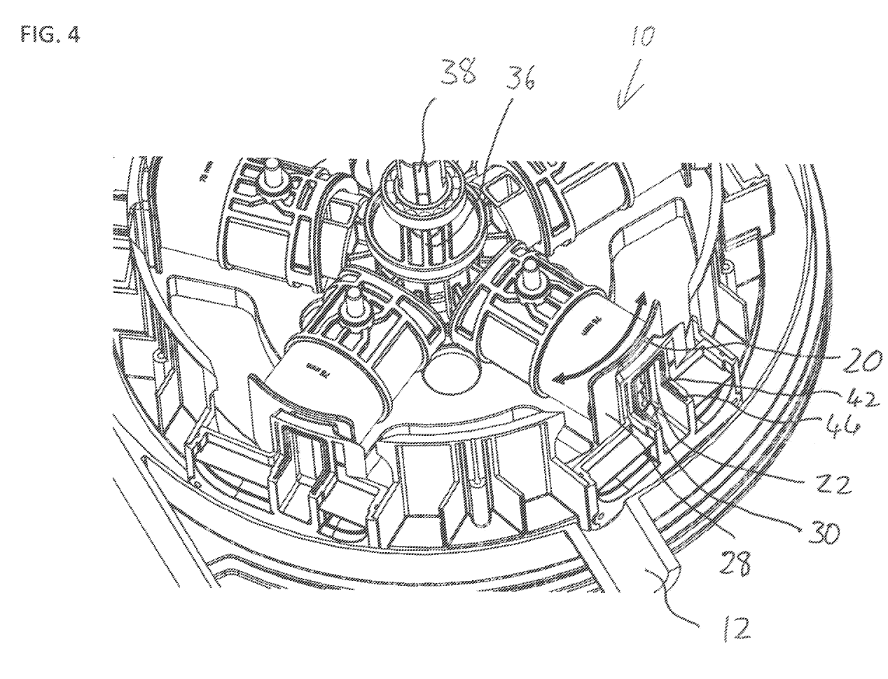

Referring now to the drawings, FIGS. 1, 2 and 3B-10B illustrate an embodiment of a motor, generally designated 10, constructed and operative according to an embodiment of the present invention, to be driven by pressurized fluid supplied via a conduit 12 from a source of pressurized fluid 14, typically via a suitable control valve arrangement (not shown).

By way of introduction, an aspect of the present invention provides a hydraulic motor driven by pressurized fluid, and in particular, suited to being driven by water pressure or air pressure. The motor has principles of operation which are somewhat similar to those of devices described in U.S. Pat. Nos. 7,258,057 and 8,881,641, but addresses certain limitations of the designs therein, as described below.

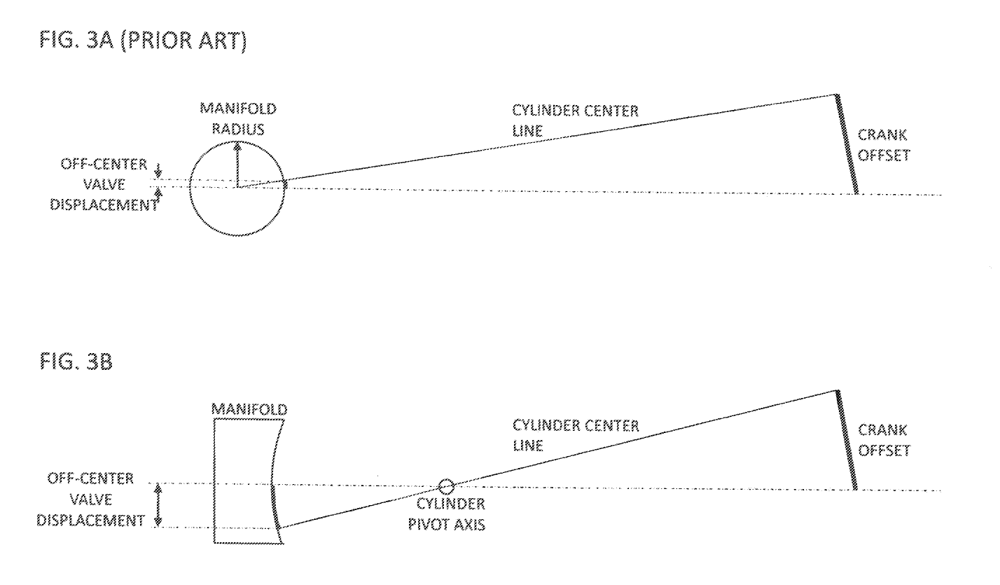

A first aspect of an embodiment of the present invention relates to mounting of each cylinder about a pivot axis that is at an intermediate location between the crank and the valve arrangement, as illustrated in the drawings. FIGS. 3A and 3B in particular compare this geometry to that of the above-referenced patents. In the above-referenced patents, the cylinder is pivotally mounted about a pipe which serves both as an axle about which the cylinders pivot and a manifold which provides pressurized fluid. Angular motion of the cylinder about the axle as the crank rotates causes intermittent overlap between the cylinder inlet and valve openings of the manifold. The extent of the sliding valve motion which effects switching between the pressure-stroke connection to the pressure line and the return stroke connection to the drain is limited by the diameter of the manifold pipe and the range of pivot angles defined by the crank and the cylinder length. This geometry is illustrated in FIG. 3A. Geometrically, the pivot axis of the cylinder in the above-referenced patents is on the far side of the valve arrangement from the crank. As a result of this structure, the “off-center valve displacement” is very limited. This in turn limits the area of the flow opening which can be opened between the pressurized fluid supply line and the cylinder, and between the cylinder and the drain. For low output power applications, even where relatively large torque is required, the flow rate limitations are typically not critical. However, as motor speed increases, there is an increasingly large pressure drop at the relatively small valve openings, with a consequent loss of efficiency.

In contrast to this geometry, an aspect of the present invention provides an alternative geometry, illustrated schematically in FIG. 3B, in which a pivot axis of each cylinder is located between the crank and the valve arrangement. This relocation of the pivot axis allows a significant increase in the range of sliding motion of the cylinder head in relation to connections to the pressure line and a drain for a given dimensions of the crank and cylinder. This in turn allows relatively larger opening of the valve passageways during each cycle of the motor, thereby reducing pressure drop across the openings and enhancing efficiency of the motor.

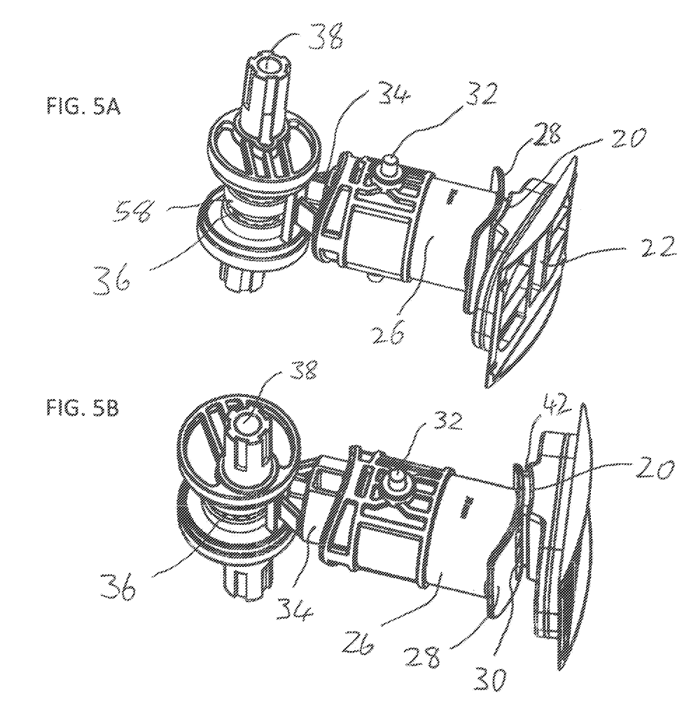

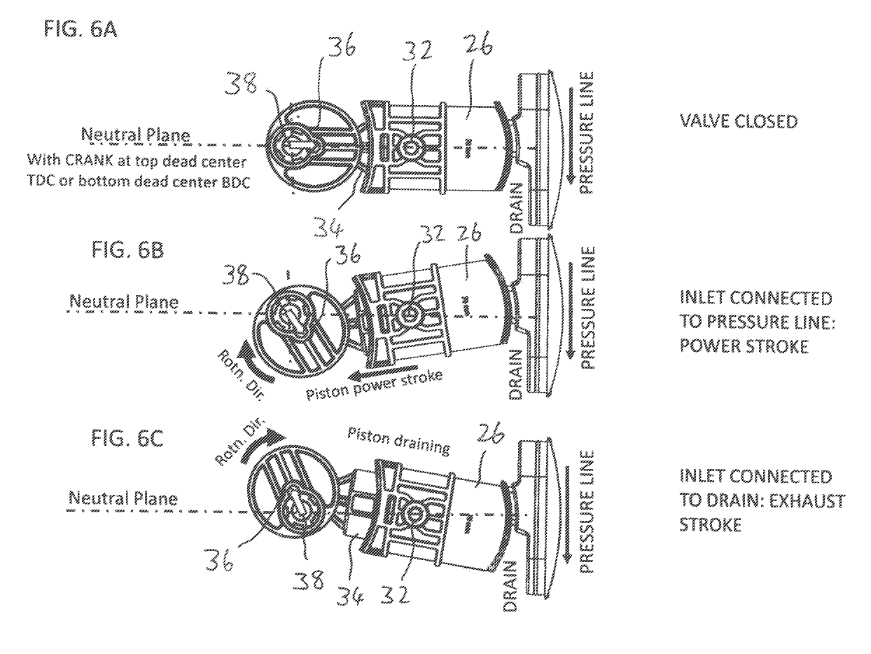

Turning now to the features of the non-limiting illustrated embodiment in more detail, motor 10 has a manifold 16 including a fluid flow channel 18 for conveying the pressurized fluid. Manifold 16 includes an arcuate surface 20 which has a valve opening 22 in fluid connection with fluid flow channel 18, surrounded by a sealing surface. The motor also includes a cylinder 26 which includes a cylinder head providing a facing surface 28 that cooperates with arcuate surface 20. Facing surface 28 has at least one aperture 30. Cylinder 26 is pivotally mounted about a pivot axis, here defined by a pivot axle 32, so as to be pivotable between:
i. a neutral state in which aperture is in facing relation to sealing surface 20, as shown in FIG. 6A;
ii. an inlet state, angularly displaced over a range of positions to a first side of the neutral state, in which aperture 30 is in fluid connection with valve opening 22 for intake of the pressurized fluid into the cylinder 26, as shown in FIGS. 5A and 6B; and
iii. an exhaust state angularly displaced over a range of positions to a second side of the neutral state, in which aperture 30 is in fluid connection with a drainage volume for exhaust of the fluid from the cylinder 26, as shown in FIGS. 5B and 6C.

A piston 34 is deployed within cylinder 26 so as to be driven to extend by pressure of the pressurized fluid introduced to an internal volume of the cylinder. Piston 34 is linked to a crank 36 which is associated with a crankshaft 38 such that rotation of crankshaft 38 about its axis delimits a cyclic motion of the piston and the cylinder so that the cylinder assumes the inlet state for an extension power stroke of the piston, passes through the neutral state and assumes the exhaust state for a return motion of the piston.

In order to generate a relatively large displacement of aperture 30 across the arcuate surface 20 according to the geometry described above with reference to FIG. 3B, it is a particular feature of certain preferred embodiments of the present invention that the pivot axis of cylinder 26, here defined by pivot axle 32, is located between the crankshaft axis and arcuate surface 20. The exact location of the pivot axis is typically on a centerline of the piston, and is in some cases advantageously within the middle third of a distance between the crankshaft axis and the arcuate surface. Additionally, or alternatively, it may be advantageous in certain cases to have the pivot axis of the cylinder located closer to the arcuate surface than to the crankshaft axis.

In order to ensure continuous operation without “dead” regions without torque, motor 10 is preferably implemented with at least three cylinder/piston arrangements as described herein which operate out of phase. For smooth operation, the motor most preferably employs at least five piston/cylinder assemblies so that two pistons are within the active part of their power stroke at any position.

The embodiment of the invention illustrated here has a radial arrangement of cylinders around a common crank linkage. It will be appreciated that an in-line design, with a series of cylinders each connected to a different crank linkage out-of-phase along a common crank shaft (analogous to FIG. 3 of the aforementioned U.S. Pat. No. 8,881,641) may be implemented in a similar manner. In the latter case, all of the cylinders may advantageously be mounted on a single common pivot axle passing through the entire row of cylinders. Other configurations, such as a V-configuration, are also possible, as will be clear to a person ordinarily skilled in the art.

As described above, each cylinder head ends in an arcuate sealing surface 28 with an opening 30 which alternately comes into alignment with the pressure line outlet (valve opening 22) or with a drain. The arcuate sealing surface seals the pressure line outlet when the cylinder opening is not aligned with the outlet.

In the particularly preferred non-limiting example illustrated here, the motor is implemented as a wet-casing motor suitable for use in a water-driven motor where the spent water expelled from each cylinder during the return stroke is released into the motor casing, from which it drains out via drain holes by gravity. In this case, drainage from the return stroke of each piston is released into the internal volume of the motor casing, corresponding to the exhaust state as illustrated in FIGS. 5B, 6C and 7B. FIGS. 6A-6C illustrate a sequence of states during the cyclic motion of each cylinder.

In alternative implementations (not shown here), the cylinder aperture 30 comes into alignment for the return stroke with a second valve opening (not shown), typically a mirror image of opening 22 in the neutral plane, via which spent hydraulic fluid is channeled to a second flow channel passing through manifold 16, for release at a suitable location or, in the case of a non-water hydraulic fluid, for return to a reservoir for re-use. Where two flow channels are provided, the motor may be provided with a control valve arrangement which selectively assumes a first state in which the control valve arrangement connects the fluid flow channel to a source of pressurized fluid and the second fluid flow channel to a drainage line, thereby driving the motor in a forward direction, and a second state in which the control valve arrangement connects the second fluid flow channel to a source of pressurized fluid and the fluid flow channel to a drainage line, thereby driving the motor in a reverse direction.

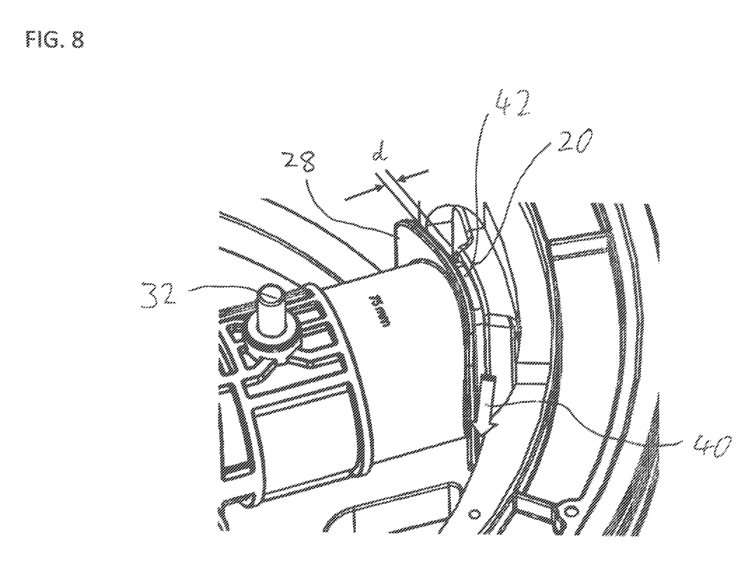

As best seen in FIGS. 5A-8, since the contact between the sealing surface at the end of the cylinder and the manifold opening(s) does not serve as a load-bearing structure, a spacing between the rigid elements can be increased to provide a significant clearance, marked as d in FIG. 8, with only a wear-resistant sealing element bridging the gap. This clearance ensure that any small solid particles carried by the driving fluid are readily flushed out to the drain, as represented schematically by arrow 40 in FIG. 8, and do not get caught in the gap.

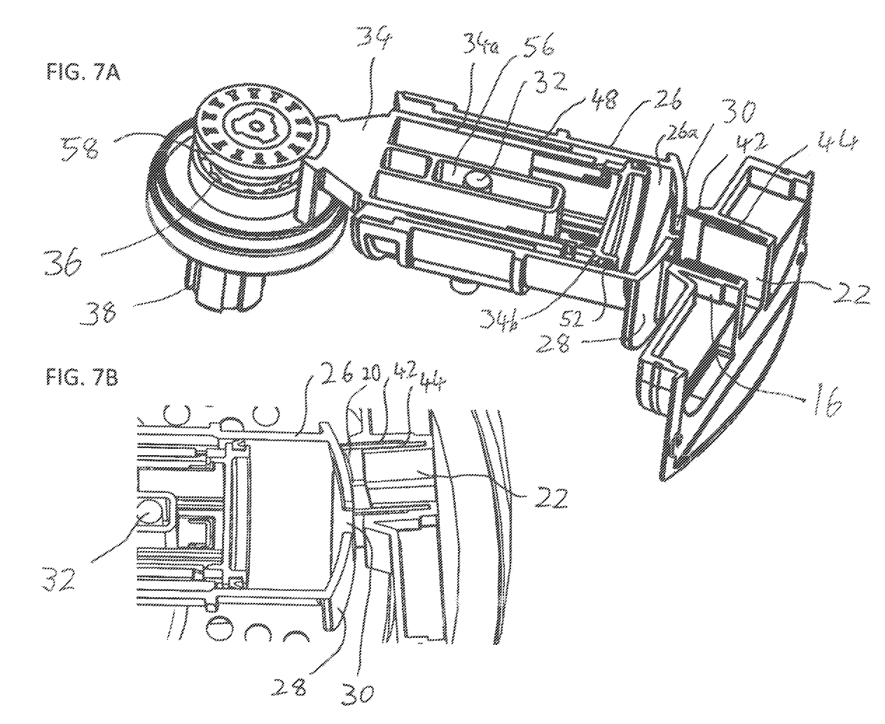

One particularly preferred implementation of the wear-resistant seal is best seen in FIGS. 7A and 7B, and employs a resiliently-mounted seal arrangement. Specifically, a wear-resistant polymer material provides an outer seal envelope 42 which is mounted in an opening of manifold 16 so as to provide both valve opening 22 and sealing surface 20. Envelope 42 is preferably made from a low friction hard plastic, such as acetal resin. A suitable composition is commercially available under the trademark DELRIN® from DuPont. Envelope 42 is biased against facing surface 28 by a polymeric liner 44, typically of silicone, which preferably also serves to seal between envelope 42 and manifold 16. Envelope 42 is thus pressed against facing surface 28 so as to form a seal between aperture 30 and valve opening 22 in the inlet state, and so as to seal aperture 30 against sealing surface 20 in the neutral state. Most preferably, the rear surface of envelope 42 opposite sealing surface 20 and around valve opening 22 is exposed to the pressurized fluid supply pressure, within fluid flow channel 18. This pressure presses envelope 42 more firmly against the cylinder head, thereby ensuring a reliable seal between sealing surface 20 and facing surface 28 throughout the cyclic motion of the cylinder.

Turning now to a particularly preferred implementation of the cylinder assemblies, this is best seen in FIGS. 7A and 9-10B. In the preferred embodiments of the present invention, the orientation of the cylinder is varied during the motor revolutions by the motion of crank 36 relative to pivot axle 32. As a result, piston 34 must transfer torque to cylinder 26 while at the same time performing its axial power and exhaust strokes. Particularly preferred implementations of the present invention avoid transferring torque via elastomeric seals, instead achieving guidance of the piston by sliding contact of hard plastic elements. One particularly preferred exemplary implementation of an assembly for this purpose will now be described.

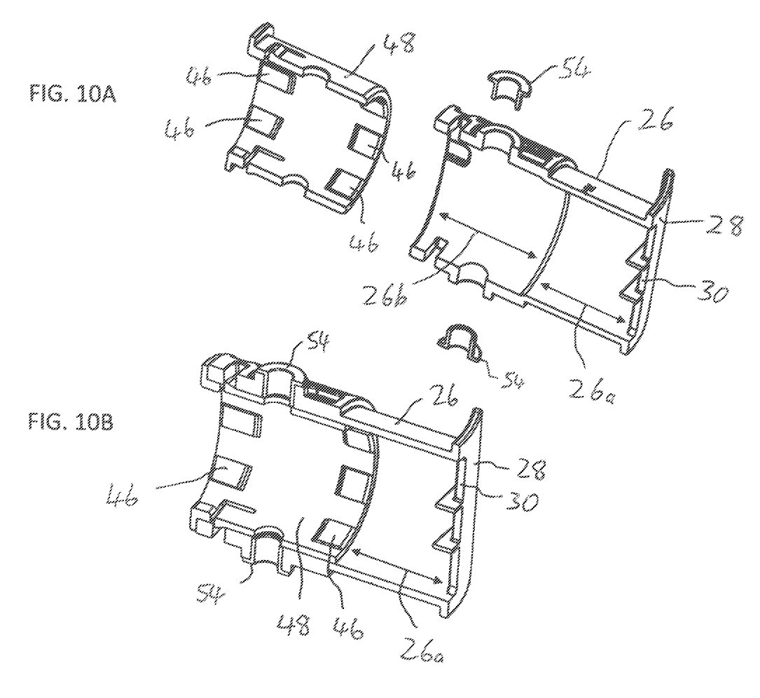

In the particularly preferred example illustrated in FIG. 10A, cylinder 26 is subdivided axially into two regions: a first “wet” region 26a in which the fluid pressure acts on the piston to perform the cylinder power stroke, and a second “dry” region 26b in which alignment surfaces ensure proper alignment of the piston within the cylinder. In order to allow insertion of the piston seal during assembly of the motor, the diameter of dry region 26b must be at least as large as that of region 26a and is, in the example shown here, slightly larger. Reliable alignment on the other hand is preferably achieved according to the teachings of the present invention at a number of inwardly-projecting sliding abutment surfaces 46. These sliding abutment surfaces are therefore preferably implemented as part of a piston guide insert 48, which is inserted into dry region 26b of the cylinder and locked in place by resilient tabs 50 or the like.

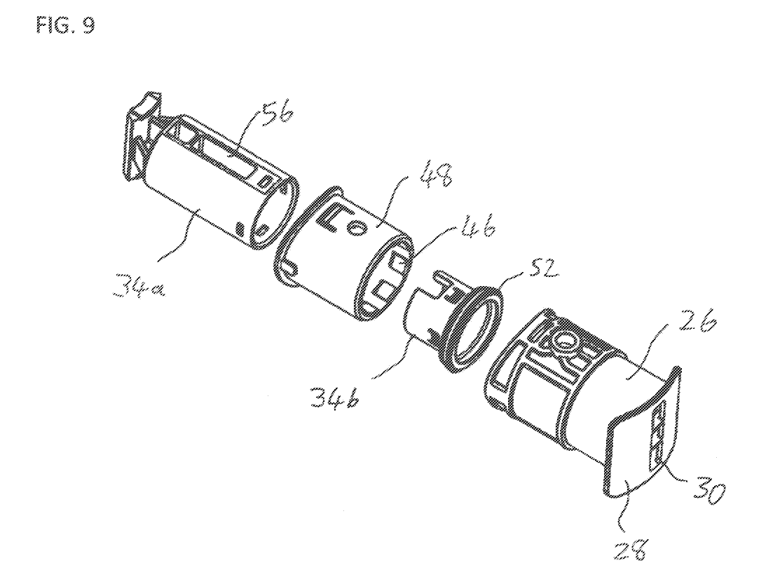

The sliding abutment surfaces 46 preferably abut external surfaces of the piston body 34a. The abutment surfaces are preferably near the two ends of piston guide insert 48 so as to provide maximum stability of guidance as a sliding linear bearing. Most preferably, sliding abutment surfaces 46 are isolated surfaces that are discontinuous around the piston body. “Isolated” in this context refers to the fact that their regions of contact are non-contiguous. In the particularly preferred implementation illustrated, the abutment surfaces are spaced apart by spaces that are at least 50% of the dimensions of the contact region. The use of localized contact surfaces while leaving large clearance around most of the surface of the piston helps to ensure that any solid particles entering the casing to not become trapped within the bearing. The linear bearing formed by these surfaces preferably contacts at a diameter which is less than the transverse dimensions of both the piston head portion 34b which supports an elastomer seal 52 and the piston body 34a which extends towards the crank end of the piston. In other words, sliding bearing surfaces 46 are preferably circumscribed by a virtual cylinder of a diameter smaller than the diameter of the region 26a of the cylinder engaged by elastomer seal 52. Assembly of a structure meeting these specifications can readily be achieved, for example, by employing a two-part piston in which piston body 34a and piston head 34b are formed as separate parts which snap together for assembly within guide insert 48, as illustrated in FIG. 9. The guide insert 48 then snap-fits within cylinder body 26, as illustrated (without the piston) in FIG. 10B. The overall assembly is best seen in FIG. 7A.

Although pivotal mounting of cylinder 26 may be achieved using external pivotal mountings, certain particularly preferred implementations of the present invention achieve particular structural strength and reliability by employing a piston pivot axle 32 which passes through cylinder 26. A bearing (bushing) 54 (FIGS. 10A and 10B) preferably reinforces and reduces friction around pivot axle 32 where it passes through the wall of cylinder 26. In order to accommodate the range of axial displacement of piston 34 within cylinder 26, piston body 26a is preferably formed with a slot 56 traversing the piston body.

The end of piston 34 that interfaces with crank 36 is preferably formed with a suitably shaped engagement portion for engaging in a rolling-element rotary bearing assembly 58 (FIGS. 5A and 7A) together with the corresponding engagement portions of the other pistons of the motor assembly.

The cylinders and pistons of most particularly preferred implementations of the present invention are formed primarily from molded plastic, rendering the device low cost and lightweight. In this context, “primarily” refers to these elements being constructed using plastic as the majority component by weight. Typically, the manifold and the entire housing are formed primarily from molded plastic components.

The use of molded plastic components and dynamically biased sealing elements is particularly suited to relatively low working pressures and to the use of environmentally friendly working fluids. In contrast to oil-based hydraulic systems which typically work at many tens, if not hundreds, of bar working pressures, the motors of the present invention most preferably work with sources of pressurized fluid providing fluid at a pressure of between 2 and 10 bar (or 2-10 atm). According to a first subset of particularly preferred applications, the pressurized fluid is water. According to another subset of particularly preferred applications, the pressurized fluid is compressed air.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A motor to be driven by a pressurized fluid comprising:
(a) a manifold comprising a fluid flow channel for conveying the pressurized fluid, said manifold providing an arcuate surface defining:
(i) a valve opening in fluid connection with said fluid flow channel, and
(ii) a sealing surface;
(b) a cylinder having a cylinder head providing a facing surface configured to cooperate with said arcuate surface, said facing surface having at least one aperture, said cylinder being pivotally mounted about a pivot axis so as to be pivotable between:
(i) a neutral state in which said aperture is in facing relation to said sealing surface,
(ii) an inlet state, angularly displaced over a range of positions to a first side of said neutral state, in which said aperture is in fluid connection with said valve opening for intake of the pressurized fluid into said cylinder, and
(iii) an exhaust, state angularly displaced over a range of positions to a second side of said neutral state, in which said aperture is in fluid connection with a drainage volume for exhaust of the fluid from the cylinder;
(c) a piston deployed within said cylinder so as to be driven to extend by pressure of the pressurized fluid introduced to an internal volume of said cylinder; and
(d) a crank associated with a crankshaft, said piston being linked to said crank such that rotation of said crankshaft about a crankshaft axis delimits a cyclic motion of said piston and said cylinder in which said cylinder assumes said inlet state for an extension power stroke of said piston, passes through said neutral state and assumes said exhaust state for a return motion of said piston,
wherein said pivot axis of said cylinder is located between said crankshaft axis and said arcuate surface.

2. The motor of claim 1, wherein said pivot axis of said cylinder is located in a middle third of a distance between said crankshaft axis and said arcuate surface.

3. The motor of claim 1, wherein said pivot axis of said cylinder is located closer to said arcuate surface than to said crankshaft axis.

4. The motor of claim 1, wherein said piston is formed with a piston head, carrying a seal for sealed engagement with a portion of said cylinder, and a piston body, rigidly interconnected with said piston head, said piston body extending from said piston head to said crank.

5. The motor of claim 4, wherein said cylinder is pivotally mounted on a pivot axle which traverses said cylinder, and wherein said piston body is formed with a slot for accommodating said pivot axle while allowing a range of axial motion of said piston.

6. The motor of claim 4, wherein said piston head seal engages a portion of said cylinder having a first internal diameter, and wherein said piston body has one or more sliding bearing surfaces for maintaining alignment of said piston within said cylinder, said sliding bearing surfaces being circumscribed by a virtual cylinder of second diameter smaller than said first diameter.

7. The motor of claim 6, further comprising a piston guide insert at least partially circumscribing said piston body, said piston guide insert providing sliding abutment surfaces for contacting said sliding bearing surfaces of said piston body, said piston guide insert being received within said. cylinder.

8. The motor of claim 7, wherein said sliding abutment surfaces are a plurality of isolated surfaces that are discontinuous around said piston body.

9. The motor of claim 1, wherein said arcuate surface and said facing surface are deployed with a clearance, the motor further comprising a resiliently-mounted seal arrangement forming a seal between said aperture and said valve opening in said inlet state, and for sealing said aperture against said sealing surface in said neutral state.

10. The motor of claim 9, wherein said resiliently-mounted seal is biased by pressure within said fluid flow channel of said manifold to enhance sealing of said resiliently-mounted seal.

11. The motor of claim 1, wherein said cylinder and said piston are formed primarily from molded plastic.

12. The motor of claim 1, wherein said drain volume is an internal volume of a housing that houses said cylinder and said piston, said housing having at least one exhaust hole for allowing egress of the fluid from said internal volume.

13. The motor of claim 1, wherein, in said exhaust state, said aperture is in fluid connection with a second valve opening formed in said arcuate surface, said second valve opening being in fluid communication with a second fluid flow channel of said manifold, for conveying, exhaust fluid from said cylinder.

14. The motor of claim 13, further comprising a control valve arrangement selectively assuming:
(a) a first state in which said control valve arrangement connects said fluid flow channel to a source of pressurized fluid and said second fluid flow channel to a drainage line, thereby driving the motor in a first direction; and
(b) a second state in which said control valve arrangement connects said second fluid flow channel to a source of pressurized fluid and said fluid flow channel to a drainage line, thereby driving the motor in a direction opposite to said first direction.

15. The motor of claim 1, wherein said cylinder is one of at least three similar cylinders, and said piston is one of at least three similar pistons, all of said pistons being connected in driving relation to said crankshaft.

16. The motor of claim 15, wherein said cylinders are arranged in a radial motor configuration.

17. The motor of claim 15, wherein said cylinders are arranged in an inline configuration.

18. A drive system comprising:
(a) a motor according to claim 1; and
(b) a source of pressurized fluid connected so as to provide pressurized fluid to said fluid flow channel of said manifold, said source of pressurized fluid providing fluid at a pressure of between 2 and 10 bar.

19. The drive system of claim 18, wherein said pressurized fluid is water.
